(19) United States
(12) Patent Application Publication
(10) Pub. No.: US 2016/0071349 A1
(43) Pub. Date: Mar. 10, 2016

(54) System and Method for Making Purchasing Decisions

(71) Applicant: Meghraj Tambaku, Mumbai (IN)

(72) Inventor: Meghraj Tambaku, Mumbai (IN)

(21) Appl. No.: 14/656,093

(22) Filed: Mar. 12, 2015

Related U.S. Application Data
(60) Provisional application No. 62/047,223, filed on Sep. 8, 2014.

(51) Int. Cl. G07C 13/00; G06Q 30/06

(52) U.S. Cl. CPC G07C 13/00; G06Q 30/0633

(57) ABSTRACT

A system and method for helping a user to decide whether to purchase a particular item by soliciting votes from the user's contacts. The system and method allows a user to create a profile and provides the user with a virtual shopping cart in which the user can place products for the user to purchase. The user can selectively allow his or her contacts, such as friends and family members, to view his or her shopping cart and the products therein. The contacts can then vote on whether the user should purchase a particular product and the votes are displayed to the user. The user may then be able to complete the purchase transaction if so desired. In this way, the user is provided with feedback regarding particular items from friends and family members when making purchasing decisions.

### CROSS REFERENCE TO RELATED APPLICATION

This application claims the benefit of U.S. Provisional Application No. 62/047,223 filed on Sep. 8, 2014. The above identified patent application is herein incorporated by reference in its entirety to provide continuity of disclosure.

### BACKGROUND OF THE INVENTION

1. Field of the Invention

The present invention relates to a system and method for making purchasing decisions. More specifically, the present invention provides a system and method for allowing a user to select one or more products and have one or more contacts of the user vote on whether the user should purchase the product in order to help the user to determine whether to purchase the product.

When making purchases online, people generally base their purchasing decisions in part on the reviews by people who have already purchased the product or service. However, the user does not know the people who wrote the reviews and the reviewers may have different purchasing preferences and may value features or aspects of a product or service that are not important to the user. The user has no means to sort or filter reviewers so as to obtain reviews from people that have similar purchasing preferences as the user. Further, reviews may be fabricated and set forth by the seller or the seller's affiliates to artificially inflate the rating of the product or service. Thus, it can be difficult for a person to make an educated decision about whether to purchase a particular product.

The present invention provides a system and method for helping a user to make a purchasing decision by soliciting reviews or recommendations from a selected group of people. The system allows a user to create a profile and to add items to a virtual shopping cart. The user can add selected persons to view the shopping cart and vote on whether the user should purchase the product. Once the user gathers votes from the people the user has selected to vote, the user can make a more informed decision regarding whether to purchase a particular product.

2. Description of the Prior Art

Devices have been disclosed in the prior art that relate to systems for making recommendations. These include devices that have been patented and published in patent application publications. These devices generally relate to systems for ranking recommendations and providing relevant reviews to a purchaser. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 7,752,082 to Calabria discloses a social network enabled review system. The review system receives, stores, and retrieves reviews based upon the subject and the user's relationship to the authors of the reviews. The review engine comprises a social network engine, a rate and rank engine, a credentials engine, and a privacy engine. The engines allow reviews to be sorted and ordered in terms of relevance to the user. Thus, Calabria provides a system for ordering and ranking reviews depending upon the user's relationship to the reviewer, and does not allow a user to allow specific users to commonly on the purchase of a particular item.

Another device, U.S. Pat. No. 8,095,432 to Berman et al. discloses a recommendation engine for social networks. Berman discloses a method for making a recommendation comprising the steps of obtaining recommendations for various items from the members of a social network. The recommendations are ranked based on relationship of the members to the user. A user can perform a search for a specific item, and the recommendations for that item are listed based upon the rankings for each recommendation. Thus, Berman et al. discloses a recommendation system that ranks recommendations based upon the reviewer's relationship to the user, but does not allow a user to seek recommendations from specific persons.

U.S. Published Patent Application Number 2011/0307340 to Benmbarek discloses a system and method for sharing user experiences. The system is adapted to display an industry category and display a customer experience rating for a company's service or product. The user can rate a provider of the service based upon their own experience. The customer experience is then shared with a social network using a web application, and additional members can be invited to share their experience with a company. Thus, Benmbarek discloses a system for sharing experience about a company's services, and does not provide a system whereby a user solicits feedback on a particular product and specifically whether the user should purchase that product.

U.S. Published Patent Application Number 2013/0117329 to Bank et al. discloses a system for providing product reviews to a user. The system monitors a user's session on a website to gather information about the user's reviewing and purchasing habits. The actions of the user are stored in a database and a personality report is generated for the user. A list of reviewers favored by the user is also generated. The personality of the user is matched with reviews of potential interest to the user in addition to reviews from reviewers favored by the user. Thus, Bank et al. fails to disclose a review system that allows a user to select reviewers to vote on whether the user should purchase a specific product.

U.S. Pat. No. 4,996,642 to Hey discloses a system and method for recommending items. The recommendations are based on other items sampled by the user. A scalar rating is defined for each item sampled by the user to represent the user's reaction to the item. The user is paired with users in a group that have defined scalar ratings for some of the items sampled by the user. User's reviews are weighted based upon whether they rated items similarly to the user. Thus, Hey discloses a system for rating items and recommending items to the user based upon their preferences, and does not disclose a system for helping a user to decide whether to purchase a specific item.

These prior art devices have several known drawbacks. The devices in the prior art generally relate to systems for making recommendations wherein users of a social network are ranked based upon their relationship to the user. Thus, the user is provided with reviews for an item from people on a user's social network. These systems however do not allow a user to select specific person to review or vote on whether the user should purchase a particular item.

In light of the devices disclosed in the prior art, it is submitted that the present invention substantially diverges in design elements from the prior art and consequently it is clear that there is a need in the art for an improvement to existing systems for making recommendations. In this regard the instant invention substantially fulfills these needs.

### SUMMARY OF THE INVENTION

In view of the foregoing disadvantages inherent in the known types of systems for recommending products now present in the prior art, the present invention provides a new system for making purchasing decisions based on reviews wherein the same can be utilized for providing convenience for the user when deciding whether to purchase a particular product.

It is therefore an object of the present invention to provide a new and improved system for making purchasing decisions that has all of the advantages of the prior art and none of the disadvantages.

It is another object of the present invention to provide a system for making purchasing decisions that allows a user to solicit feedback regarding whether to purchase a particular product.

Another object of the present invention is to provide a system for making purchasing decisions that allows a user to select a group of people to vote on whether the user should purchase the product.

Yet another object of the present invention is to provide a system for making purchasing decisions that allows a user to obtain recommendations on his or her mobile device, computer, or other similar electronic device.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flowchart of the method of making a purchasing decision of the present invention.

FIG. 2 shows a view of a graphical user interface showing a virtual shopping cart and contact list.

FIG. 3 shows a view of a graphical user interface showing a product and voting options.

FIG. 4 shows a view of a graphical user interface showing the voting results.

### DETAILED DESCRIPTION OF THE INVENTION

Reference is made herein to the attached drawings. Like reference numerals are used throughout the drawings to depict like or similar elements of the system for making recommendations. For the purposes of presenting a brief and clear description of the present invention, the preferred embodiment will be discussed as used for helping a user to make purchasing decisions by allowing the user to poll a selected group of persons. The figures are intended for representative purposes only and should not be considered to be limiting in any respect.

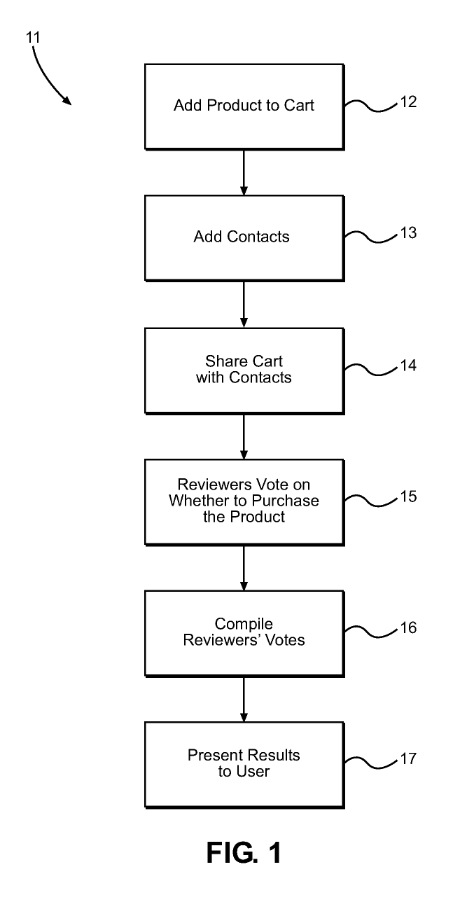

Referring now to FIG. 1, there is shown a flowchart of the method of making a purchasing decision of the present invention. The present invention provides a software application 11 executable on a computer, tablet, smartphone, or other similar electronic device. The software application 11 includes a graphical user interface that allows a user to select products for the user to potentially purchase. The user can select a product from any online retailer and add the product to a virtual shopping cart 12. For example, the user may select several brands or versions of a similar product, such as several coffee makers. Alternatively, the user can simply add a variety of different and unrelated products.

Additionally, the user can add friends, relatives, and other persons as contacts 13. The user can send a request to a person to serve as a contact for the user directly via the software application. If the person accepts the request, the person will be listed on a list of contacts on the user's software application. The contacts can be grouped into subgroups as desired by the user. For example, one subgroup may be created for contacts that are familiar with electronics and another subgroup for contacts that are familiar with fashion or clothing. Once the user has one or more contacts, the user can select to share one or more of the products 14 in his or her shopping cart with one or more of the contacts, or with one or more subgroups of the contacts. The contacts can then view the selected products and vote 15 on whether the user should purchase that product.

Each contact is shown one or more pictures and a description of the product as it appears on the website from which the product was identified. The contact must then vote on whether the contact thinks the user should buy the product, not buy the product, or indicate that the contact is undecided or has no opinion 15. The contact may also provide comments or a review about the product, such as whether the contact has also purchased the specific product or a similar product. The contact is free to explain why the user should or should not purchase the product. The contacts may be given a predetermined period of time, such as three days, to respond to the request for the contact to vote.

As the contacts vote on whether the user should or should not purchase the product, the votes are recorded in a database and the data is compiled 16. The data is then displayed to the user 17 showing the number of users that have voted to purchase, the number of users that have voted to not purchase, and the number that were undecided or that did not vote. Further, each of the comments is displayed for the user to consider. In this way, the user receives feedback on whether to buy a particular product from his or her friends, family, and other reviewers of the user's choice. Further, the votes for purchasing and against purchasing may be displayed as a percentage of the total voters. The user can then consider the contacts reviews and decide whether to purchase the product. The user may then be able to complete the purchase using the software application 11 of the present invention.

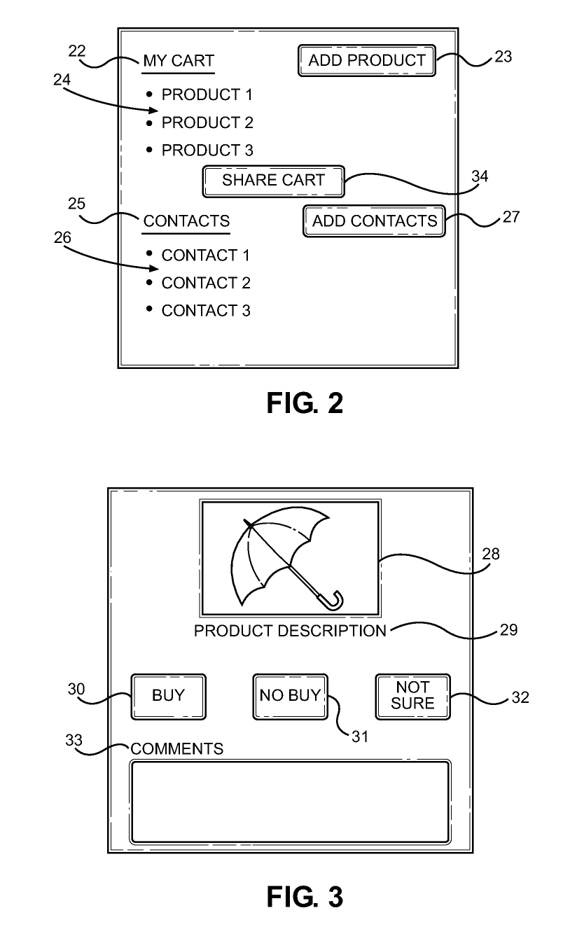

Referring now to FIG. 2, there is shown a view of a graphical user interface showing a virtual shopping cart and contact list. The graphical user interface displays a shopping cart 22 wherein the user can add 23 one or more products 24. Once the user has added a desired number of products 24, the user can select to share 34 one or more products 24 or the entire cart 22 with one or more of his or her contacts 26 or with one or more subgroups of contacts. The list of contacts 25 displays each of the user's contacts 26. The user can periodically add or remove contacts 27 from the contact list 25, and can add or remove products 24 from the shopping cart 22.

Referring now to FIG. 3, there is shown a view of a graphical user interface showing a product and voting options. Once the user has shared a product or shopping cart with his or her contacts, the contacts can review each product and information about the product. Preferably, one or more images 28 of the product are shown in addition to a brief description 29 of the product. The description may be generated from the website or retailer that sells the product.

The contact is further presented with voting options that indicate whether the contact thinks the user should make the purchase, should not make the purchase, or whether the contact is unsure of what the user should do. In the illustrated embodiment, the contact is present with the ability to vote to “buy” 30, “no buy” 31, or to indicate that the contact is “not sure” 32 if the user should buy or not buy the product. The options may include any variation of these selections, such as purchase, do not purchase, and undecided, among others.

The contact can also choose to write in a more detailed comment 33 when voting. The contact can indicate whether the contact has purchased the product, or knows someone that has purchased the product. Further, the contact may indicate that he or she has heard positive reviews about the product or has heard negative reviews about the product. Alternatively, the contact may express statements about the product itself and the product's description to help the user make a decision about whether to buy the product.

When the contact selects a voting option, the vote is compiled with the votes of the other contacts. The contacts may be given a predetermined period of time in which to respond to the request for votes. Thus, the user may set the time for the contacts to vote, and the period for voting may be closed after the predetermined time has expired. This helps to ensure the user obtains the required information by a certain date or time, such as before an auction for a product expires, or before a sale on a product ends. The results of the user's votes may be displayed to the user as the votes are being gathered. Alternatively, the votes may only be displayed to the user once all contacts make a selection of whether the user should buy or not buy the product or once the period for voting has ended.

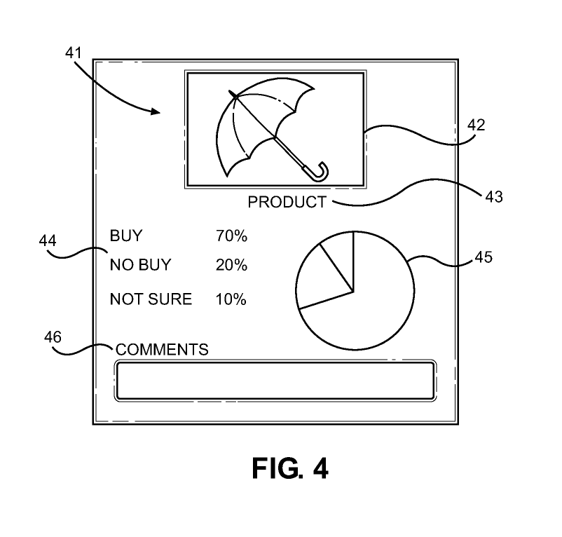

Referring now to FIG. 4, there is shown a view of a graphical user interface showing the voting results. Once the contacts have voted, the user can check to see the votes of his or her contacts. One or more images 42 of the product are displayed in addition to the product's name 43. Additional information about the product can also be provided in alternate embodiments, including a description of the product, the price, and information about the product's manufacturer or retailer.

The graphical user interface further displays the voting results in numerical 44 and/or graphical 45 form. The votes can be expressed in percentages for each category, i.e. “Buy”, “No Buy”, and “Not sure.” Alternatively, the votes can be expressed in terms of the raw number of votes, such as ten votes for “buy,” six votes for “no buy,” and two votes for “not sure.” Additionally, the votes can be shown in graphical form, such as a pie chart or bar graph. In some embodiments, the user may be able to select the form in which the results will be displayed.

In addition to displaying the votes of the contacts, the interface further displays the various comments 46 of the users. The comments may show the name of the contact who wrote the comment in addition to the comment itself. This allows the user to assess the reasons why a contact voted for the user to purchase or not purchase the product.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of soliciting reviews for making a purchasing decision, comprising the steps of:
receiving a selection of a product or a service from a user;
soliciting one or more contacts selected by a user to cast a vote on whether said user should purchase said product or said service;
compiling said votes of said one or more contacts;
displaying said votes of said one or more contacts to said user.

2. The method of soliciting reviews for making a purchasing decision of claim 1, wherein said step of receiving a selection of a product or a service from a user further comprises the steps of:
adding said one or more products or services selected by said user to a virtual shopping cart;
sharing said virtual shopping cart with one or more of said one or more contacts.

3. The method of soliciting reviews for making a purchasing decision of claim 2, wherein said one or more contacts are given a predetermined period of time in which to cast said vote.

4. The method of soliciting reviews for making a purchasing decision of claim 1, further comprising the step of:
creating one or more subgroups into which said one or more contacts can be categorized.

5. The method of soliciting reviews for making a purchasing decision of claim 1, further comprising the step of:
completing a purchase of said one or more products.

6. A computer system for soliciting reviews for making a purchasing decision, comprising:
means for selecting one or more products;
means for designating one or more persons as reviewers;
means for soliciting said reviewers to cast votes on whether a user should purchase said one or more products;
means for compiling said votes and presenting said votes to a user.
